(19) United States
(12) Patent Application Publication
(10) Pub. No.: US 2017/0070566 A1
(43) Pub. Date: Mar. 9, 2017

(54) METHOD AND COMPUTER NETWORK FOR TRANSMITTING MESSAGES

(71) Applicant: FTS COMPUTERTECHNIK GMBH, Wien (AT)

(72) Inventor: Wilfried STEINER, Wien (AT)

(21) Appl. No.: 15/120,805

(22) PCT Filed: Feb. 2, 2015
(86) PCT No.: PCT/AT2015/050037

§ 371 Date: Aug. 23, 2016

(30) Foreign Application Priority Data
Feb. 24, 2014 (AT) A 50137/2014

(51) Int. Cl. H04L 29/08; H04L 12/44; H04L 12/761

(52) U.S. Cl. CPC H04L 67/104; H04L 45/16; H04L 12/44

(57) ABSTRACT

The invention relates to a method for transmitting messages in a computer network and to a corresponding computer network. A first group of components is provided, wherein the components of the first group send and/or forward and/or receive messages via one or more wired link(s) (110), wherein each component of the first group is either a computing node (101, 102, 103, 104, 105, X108), a star coupler (201, 203, 205, 207, 210, 211, X201), or a star coupler of a multi-hop network (1000), and wherein a second group of components is provided, wherein the components of the second group send and/or forward and/or receive messages via one or more wireless link(s) (110a, 110b, 110c, 110d), wherein each component of the second group is either a computing node (107, 108, X107, X109) or a star coupler (201, 210, 211, X201, X202), and wherein each component of the first and the second group has a local clock, and wherein the clocks of the components of the first and the second group are synchronised to one another or are synchronised with one another, and wherein the components of the first and the second group send and/or forward and/or receive messages in a coordinated manner in accordance with a common communications schedule.

The invention relates to a method for transmitting messages in a computer network, wherein the computer network comprises two or more computing nodes, which computing nodes are interconnected via one, two or more star couplers and/or at least one multi-hop network, wherein each computing node is connected via at least one wireless or wired communications link to a star coupler or a multi-hop network, and wherein the computing nodes exchange messages with one another and with the one or more star coupler(s) and/or multi-hop network(s).

The invention also relates to a computer network for transmitting messages, wherein the computer network, in particular a real-time computer network, comprises two or more computing nodes, said computing nodes being interconnected via one, two or more star couplers and/or at least one multi-hop network, wherein each computing node is connected via at least one wireless or wired communications link to a star coupler or a multi-hop network, and wherein the computing nodes exchange messages with one another and with the one or more star coupler(s) and/or multi-hop network(s).

The invention lies in the field of computer networks, in particular in the field of distributed real-time systems, wherein such a computer network, in particular a real-time system, can consist for example of the following types of active components: computing nodes and star couplers. Computing nodes execute functions such as the measurement of characteristics of physical processes by means of suitable sensors, the calculation of control variables, or the activation of actuators, such as valves. Star couplers receive messages from computing nodes and/or other stark couplers and forward messages to compute in nodes and/or star couplers. Star couplers are for example bridges, switches and/or routers in a wired communication or access points in a wireless communication. Computing nodes are connected to other computing nodes and/or star couplers by means of wired or wireless, preferably bi-directional links (i.e. communications links). Furthermore, star couplers can also be interconnected by wired or wireless, preferably bi-directional links.

The term line or communications line is also used synonymously for the term link (communications link) and designates both wired and wireless links. If the fact whether the link is wireless or wired is of significance, this will be separately emphasised.

The object of the invention is to ensure, in a mixed wired and wireless network, that messages can be communicated with short and constant transmission duration.

This object is achieved, in accordance with the invention, with a method of the type described in the introduction and a computer network of the type described in the introduction in that
a first group of components is provided, wherein the components of the first group send and/or forward and/or receive messages via one or more wired link(s), wherein the first group comprises one, two, or more component(s), and wherein each component of the first group is either a computing node, a star coupler, or a star coupler of a multi-hop network, and wherein
a second group of components is provided, wherein the components of the second group send and/or forward and/or receive messages via one or more wireless link(s), wherein the second group comprises one, two, or more component(s), and wherein each component of the second group is either a computing node or a star coupler, and wherein
each component of the first and the second group has a local clock, and wherein
the clocks of the components of the first and the second group are synchronised to one another or are synchronised with one another, and wherein
the components of the first and the second group send and/or forward and/or receive messages in a coordinated manner in accordance with a common communications schedule.

The messages are sent and/or received and/or forwarded in a time-triggered manner accordingly. Due to the use of a common communications schedule in a mixed wired and wireless network, it is ensured that messages can be communicated with short and constant transmission duration. In contrast to the prior art, the invention makes it possible for any wireless segments, i.e. sub-networks, which are connected by wired communications links to be able to exchange messages in a synchronised and time-triggered manner. The invention enables a network designer to have the greatest degree of flexibility in the network design in that wired communications links can be replaced for wireless communications links.

Preferred embodiments of the method according to the invention and of the computer network according to the invention, which can be implemented individually or in any combination with one another, are described hereinafter.
Provision is also made advantageously for one, two, or more of the components of the first group to also send and/or receive and/or forward messages via one or more wire-less links.

Here, provision is preferably made for the components of the first group that send and/or receive and/or forward messages via one or more wireless links to send and/or receive and/or forward these messages in accordance with the common communications schedule.
Provision can advantageously be made, additionally or alternatively, for one, two, or more of the components of the second group to also send and/or receive and/or forward messages via one or more wired links.

Here, provision is advantageously made for the components of the second group that send and/or receive and/or forward messages via one or more wired links to send and/or receive and/or forward these messages in accordance with the common communications schedule.
It is in particular advantageous when the sending times of the time-triggered messages in the communications schedule are selected in such a way that time-triggered messages are sent at the same time or in an overlapping manner only over those wireless communications links in which there is no disturbance of the message transmission.

In this way, the communications schedule thus ensures that messages are communicated simultaneously over a plurality of wireless communications links only when there is no disturbing influence, for example when the wireless communications links are spatially distanced far enough from one another, or when messages are sent at different communications frequencies. Here, the communications schedule also determines the lines via which messages are communicated.

Due to the colliding nature of the wireless transmission medium, the destruction or delay of individual messages must be regularly excepted when attempting to transmit a number of messages simultaneously over different wireless transmission paths located close to one another. This destruction or delay of messages casts doubt on the suitability of use of the wireless transmission medium for certain purposes in the field of “real-time control” and other purposes characterised by real-time requirements of the communication.

Due to the present advantageous embodiment/invention, the destruction and delay of messages over wireless transmission media can be avoided to the greatest possible extent by coordination measures, and the use of this transmission medium in a mixed wired-wireless network can thus been made possible in a worthwhile manner. The corresponding coordination measures are designed accordingly in such a way that the wireless message transmissions are arranged and executed chronologically relative to one another such that a collision of these messages with one another is reliably avoided.
Messages are advantageously transmitted via wired communications links in accordance with an IEEE 802.3 standard or a standard based thereon or following on therefrom.
Messages are advantageously transmitted via wireless communications links in accordance with an IEEE 802.11 standard or a standard based thereon or following on therefrom, or in accordance with an IEEE 802.15 standard or a standard based thereon or following on therefrom.
For time-triggered communication, one or more of the following standards or standards based thereon or following on therefrom is/are preferably used: SAE AS6802, IEEE 802.1Q, IEEE 802.1AS, IEEE 1588.

The invention will be explained in greater detail hereinafter on the basis of the drawing, in which

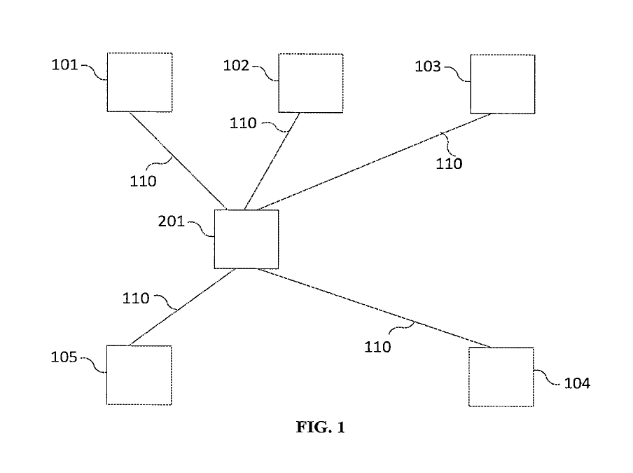

FIG. 1 shows an example of a network in which computing nodes are connected to a star coupler by means of wired communications links (communications lines),

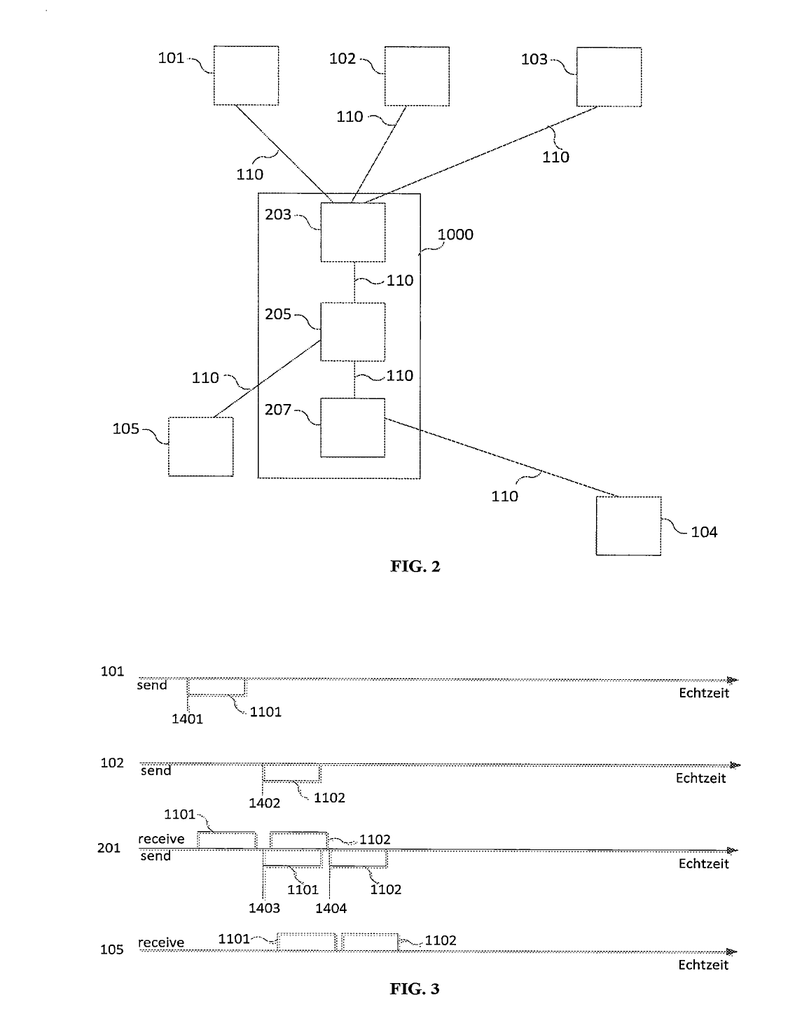

FIG. 2 shows a network in which a variety of star couplers of the network are interconnected and computing nodes of the network are each connected only to a subset of these star couplers,

FIG. 3 shows an example for time-triggered communication on the basis of a flow diagram,

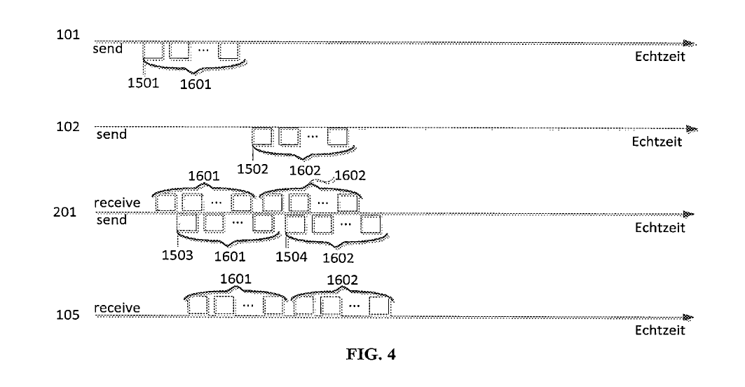

FIG. 4 shows a further example for time-triggered communication on the basis of a flow diagram,

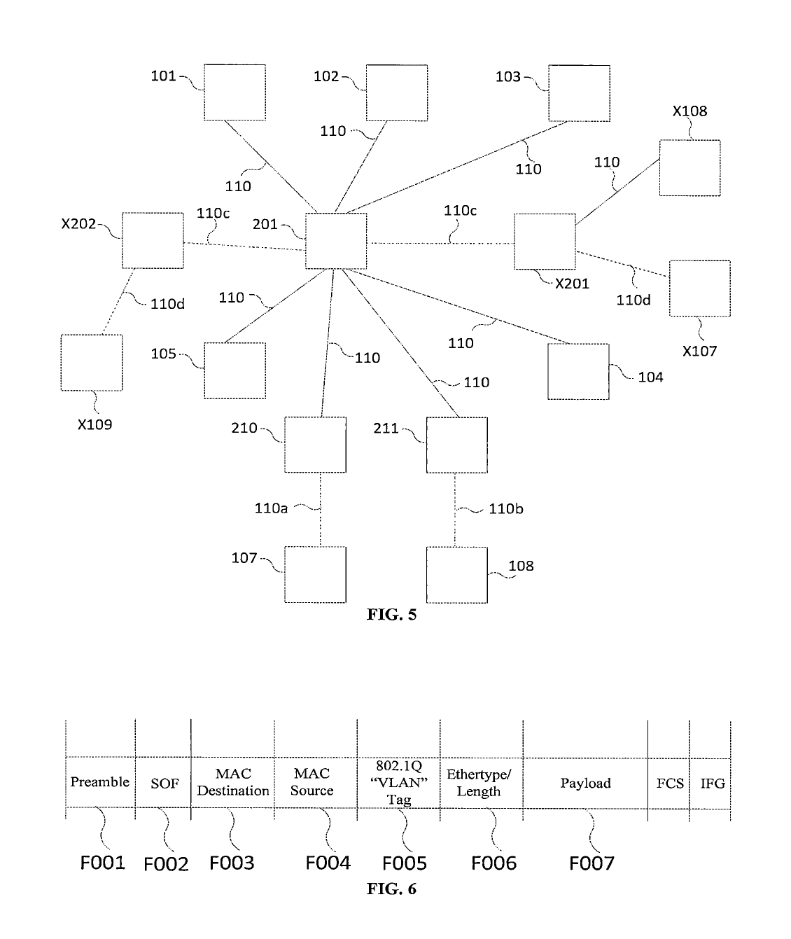

FIG. 5 shows an example of a network in which computing nodes are connected to star couplers via communications lines,

FIG. 6 shows the Ethernet message format as an example for messages that are communicated in a distributed real-time system via wired links,

FIG. 7 shows the message format of the IEEE 802.11 standard as an example for messages which are communicated in a distributed real-time system via wireless links,

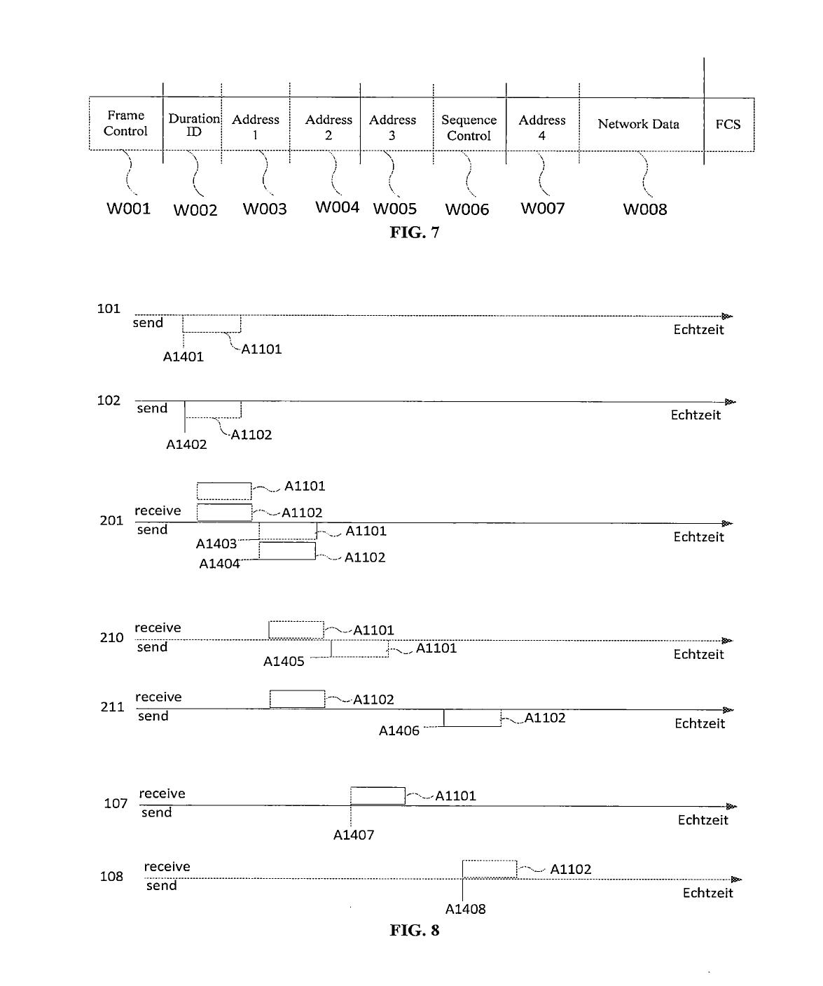

FIG. 8 shows an example for time-triggered communication in the mixed wireless and wired network of FIG. 5 on the basis of a flow diagram,

FIG. 9 shows a communications schedule relating to the flow diagram from FIG. 8,

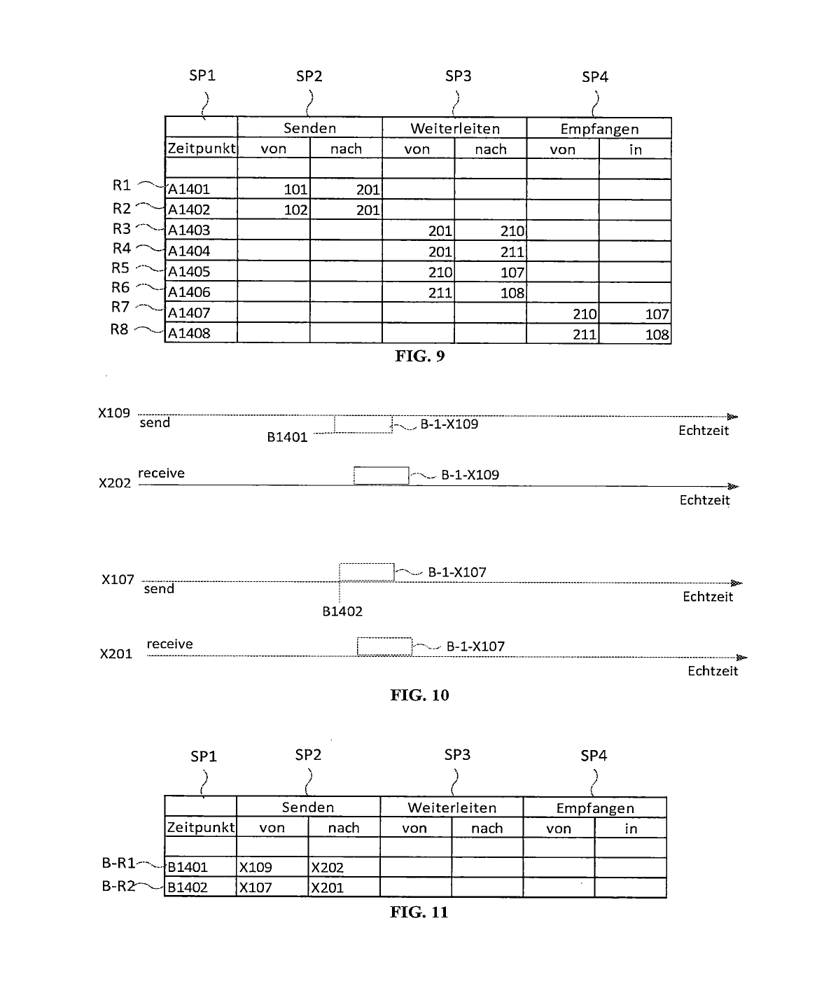

FIG. 10 shows an example for time-triggered communication in the network from FIG. 5 on the basis of a flow diagram,

FIG. 11 shows, by way of example, the communications schedule relating to the flow diagram in FIG. 10,

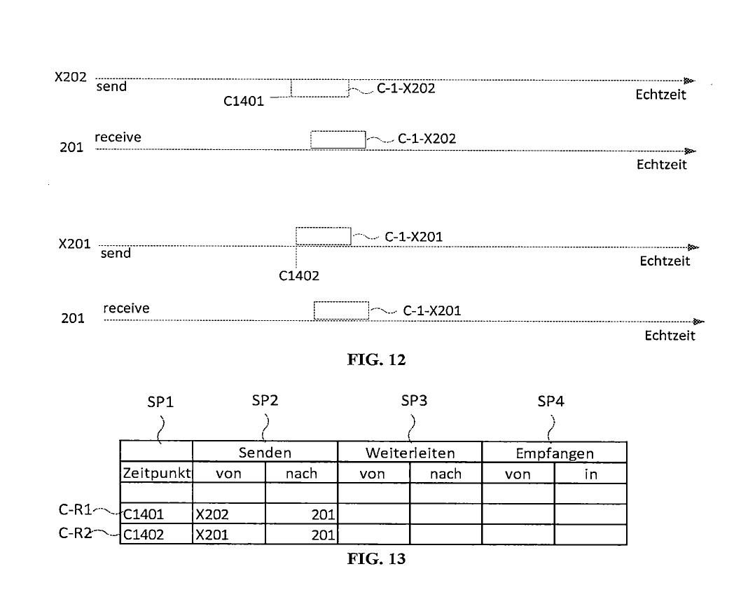

FIG. 12 shows a further example for time-triggered communication in the network from FIG. 5 on the basis of a flow diagram, and

FIG. 13 shows, by way of example, the communications schedule relating to the flow diagram in FIG. 12.

It should first be noted that the information exchange between components functions in a message-oriented manner, for example by means of Ethernet messages over wired links and by means of 802.11 messages via wireless links. In addition, no further details regarding the message format with the transmission of messages will be specified hereinafter. Specifically, it will not be discussed and it will be assumed for the sake of simplicity that, if provided, in the event of a transmission between wired and wireless links, the message formats will be translated into standard-compliant formats (for example IEEE 802.3 and 802.11 or 802.15), as is known from the prior art and not be described here in greater detail.

FIG. 1 shows an example of a network in which computing nodes 101-105 are connected to a star coupler 201 by means of wired communications links (communications lines) 110, which are advantageously bi-directional wired communications links. The computing nodes 101-105 exchange messages with one another by sending these to the star coupler 201, which forwards the messages to the appropriate receivers. Furthermore, a star coupler 201 can also itself generate messages and send these to computing nodes 101-105.

FIG. 2 shows that a plurality of star couplers 203, 205, 207 of a network can also be interconnected, and that computing nodes 101-105 of the network can each be connected only to a subset of these star couplers 203, 205, 207. The communication between two computing nodes can then be implemented also via two or more star couplers 203, 205, 207. Such network structures are referred to as multi-hop networks 1000. In the following description, reference will not be made explicitly to multi-hop networks, however it is known prior art that an individual star coupler 201 (FIG. 1) can be replaced for a multi-hop network 1000 (FIG. 2).

Time-triggered communication is illustrated by way of example in FIG. 3 on the basis of a flow diagram. In this example the computing nodes 101 and 102 as illustrated in FIG. 1 transmit messages 1101 and 1102 in a time-triggered manner to the computing node 105 via the star coupler 201. The particular feature of a time-triggered communication lies in the fact that the sending times 1401, 1402 and/or the forwarding times 1403, 1404 of the time-triggered messages are already known prior to the sending of the message. The sending times 1401, 1402 and/or the forwarding times 1403, 1404 can be determined for example already during the design stage of the distributed real-time system. The determination of the sending times, forwarding times, receiving times or a subset of these times is referred to as the communications schedule. A synchronisation of local clocks in the computing nodes and star couplers makes it possible for the communications schedule to be designed synchronously in the computing nodes and/or star couplers. For synchronisation of the local clocks, a clock synchronisation protocol can be used, such as SAE AS6802, IEEE 1588, or IEEE 802.1AS.

FIG. 4 shows a further example on the basis of a flow diagram illustrating time-triggered communication. Here, a sending time 1501, 1502 and a forwarding time 1503, 1504 are each assigned groups 1601, 1602 of time-triggered messages. As illustrated in FIG. 4, the assignment of messages to the groups 1601, 1602 remains. However, this is not necessarily the case, and therefore the star coupler 201 could implement only the forwarding time 1503 and, when the forwarding time 1503 is reached, could forward all messages of the groups 1601 and 1602. Generally, the assignment of message to a group can be reorganised arbitrarily per computing node and star coupler.

FIG. 5 shows an example of a network in which computing nodes 101-108, X107, X108, X109 are connected to one or more star couplers 201, 210, 211, X201, X202 via preferably bi-directional communication lines, 110, 110a, 110b, 110c, 110d. The preferably bi-directional communications lines 110a, 110b, 110c, 110d are wireless in this example, the preferably bi-directional communications lines 110 are wired.

In the sense of the present invention, the components 101-105, X108 are assigned exclusively to group 1, that is to say communicate via wired links 110. The components 107, 108, X107, X109, X202 belong exclusively to group 2, that is to say communicate exclusively via wireless links 110a, 110b, 110c, 110d. The components 201, X201, 210, 211 can communicate both via wired and wireless links, and therefore belong both to group 1 and to group 2 in accordance with this terminology.

In accordance with the invention, the local clocks of these components are synchronised to one another and the components of the first and the second group communicate in accordance with a common communications schedule, as will be explained in greater detail on the basis of FIG. 8.

In FIG. 6 the Ethernet message format is illustrated as an example for messages that can be communicated in a distributed real-time system via wired links. As illustrated, the Ethernet message format consists of different fields F001-F007, FCS, IFG.

In FIG. 7 the message format of the IEEE 802.11 standard is illustrated as an example for messages which can be communicated in a distributed real-time system via wireless links. As illustrated, the message format consists of different fields W001-W008, FCS.

FIG. 8 shows an example on the basis of a flow diagram illustrating time-triggered communication in the mixed wireless and wired network of FIG. 5. The example starts with computing node 101, which at the time A1401 sends a time-triggered message A1101 to the star coupler 201. Approximately at the same time, computing node 102 also sends a time-triggered message A1102 to the star coupler 201. The star coupler 201 receives both messages A1101 and A1102 and forwards these at the times A1403 and A1404 to the respective star couplers 210 and 211. The communication between the computing nodes 101, 102 and the star couplers 201, 210, 211 is implemented via a wired communications link 110, via which different messages can be transmitted at the same time. The two star couplers 210 and 211 forward the respective messages in each case via a wireless communications link 110a, 110b to the two computing nodes 107 and 108. In this example we will assume that the messages A1101 and A1102 would disturb one another in the event of simultaneous forwarding via the wireless link, for example because both transmissions would take place at the same transmission frequency. The communications schedule of the time-triggered communication is therefore selected in such a way that the two star couplers 210 and 211 forward messages A1101 and A1102 at different times A1405, A1406. As shown in FIG. 8, the two computing nodes 107 and 108 therefore receive the messages via the wireless communications lines at different times (times A1407, A1408), in accordance with the communications schedule. Due to the difference in time, which is predefined by the communications schedule, it is ensured that the transmissions of the two messages. A1101 and A1102 do not disturb one another.

FIG. 9 shows, by way of example and in the form of a table, the communications schedule relating to the flow diagram in FIG. 8. The table in FIG. 9 consists of four main columns and eight entries in rows (R1-R8). The four main columns describe: a time SP1 at which an action is to be performed, the sending SP2 of a message at the time SP1 from one component to another component, the forwarding SP3 of a message from one component to another component, and the receipt SP4 of a message in one component from another component.

FIG. 10 demonstrates an example for time-triggered communication in the network from FIG. 5 on the basis of a flow diagram. This example describes transmissions of messages via wireless communications lines 110d, which take place approximately at the same time, specifically between the computing node X109 and star coupler X202, and between computing node X107 and star coupler X201. In this example it is assumed that the messages do not disturb one another in the event of simultaneous transmission; for example, there are no disturbances because the components operate in a manner spatially separated sufficiently far from one another. Therefore, provision can be made in the communications schedule for, as shown, the two computing nodes X109, X107 to transmit the messages B-1-X109, B-1-X107 in close chronological succession to one another (or also at the same time) at the times B1401, B1402 to the star couplers X202, X201 (see communications schedule from FIG. 12), where they are likewise received in close chronological succession to one another (or at the same time), without the transmissions disturbing one another.

FIG. 11 shows, by way of example and in table form, the communications schedule relating to the flow diagram in FIG. 10. The table in FIG. 11 consists of four main columns and two entries in rows (B-R1, B-R2). The four main columns describe: a time SP1 at which an action is to be performed, the sending SP2 of a message at the time SP1 from one component to another component, the forwarding SP3 of a message from one component to another component, and the receipt SP4 of a message in one component from another component.

FIG. 12 demonstrates a further example for time-triggered communication in the network from FIG. 5 on the basis of a flow diagram. As shown, the example describes transmissions of messages via wireless communications lines 110c which take place approximately at the same time, specifically between the star coupler X202 and star coupler 201, and between star coupler X201 and star coupler 201. In this example, it is assumed that the messages do not disturb one another in the event of simultaneous transmission. In this case there is, for example, no mutual disturbance because the components use different transmission frequencies.

FIG. 13 shows, by way of example and in table form, the communications schedule relating to the flow diagram in FIG. 12. The table in FIG. 13 consists of four main columns and two entries in rows (C-R1, C-R2). The four main columns describe: a time SP1 at which an action is to be performed, the sending SP2 of a message at the time SP1 from one component to another component, the forwarding SP3 of a message from one component to another component, and the receipt SP4 of a message in one component from another component.

In accordance with the communications schedule from FIG. 13, the star coupler X202 sends a message at the time C1401 to the star coupler 201, the star coupler X201 sends a message at the time C1402 to the star coupler 201. Since there are no disturbances, the times C1401, C1402 can be close to one another or can be the same.

1. A method for transmitting messages in a computer network, wherein the computer network comprises two or more computing nodes (101-108, X107, X108, X109), which computing nodes (101-108, X107, X108, X109) are interconnected via one, two, or more star couplers (201, 203, 205, 207, 210, 211, X201, X202) and/or at least one multi-hop network (1000), wherein each computing node (101-108, X107, X108, X109) is connected to a star coupler (201, 203, 205, 207, 210, 211, X201, X202) or a multi-hop network (1000) via at least one wireless or wired communications link (110, 110a, 110b, 110c, 110d), and wherein the computing nodes (101-108, X107, X108, X109) exchange messages with one another and with the one or more star couplers (201, 203, 205, 207, 210, 211, X201, X202) and/or multi-hop network (1000),
wherein:
a first group of components is provided, wherein the components of the first group send and/or forward and/or receive messages via one or more wired link(s) (110), wherein the first group comprises one, two, or more component(s), and wherein each component of the first group is either a computing node (101, 102, 103, 104, 105, X108), a star coupler (201, 203, 205, 207, 210, 211, X201), or a star coupler of a multi-hop network (1000),
a second group of components is provided, wherein the components of the second group send and/or forward and/or receive messages via one or more wireless link(s) (110a, 110b, 110c, 110d), wherein the second group comprises one, two, or more component(s), and wherein each component of the second group is either a computing node (107, 108, X107, X109) or a star coupler (201, 210, 211, X201, X202),
each component of the first and the second group has a local clock,
the clocks of the components of the first and the second group are synchronised to one another or are synchronised with one another,
the components of the first and the second group send and/or forward and/or receive messages in a coordinated manner in accordance with a common communications schedule.

2. The method according to claim 1, wherein one, two, or more of the components of the first group also send and/or receive and/or forward messages via one or more wireless links.

3. The method according to claim 2, wherein the components of the first group that send and/or receive and/or forward messages via one or more wireless links send and/or receive and/or forward these messages in accordance with the common communications schedule.

4. The method according to claim 1, wherein one, two, or more of the components of the second group also send and/or receive and/or forward messages via one or more wired links.

5. The method according to claim 4, wherein the components of the second group that send and/or receive and/or forward messages via one or more wired links send and/or receive and/or forward these messages in accordance with the common communications schedule.

6. The method according to claim 1, wherein the sending times of the time-triggered messages in the communications schedule are selected in such a way that time-triggered messages are sent at the same time or in an overlapping manner only over those wireless communications links with which there is no disturbance of the message transmission.

7. The method according to claim 1, wherein messages are transmitted via wired communications links in accordance with an IEEE 802.3 standard or a standard based thereon or following on therefrom.

8. The method according to claim 1, wherein messages are transmitted via wireless communications links in accordance with the IEEE 802.11 standard or a standard based thereon or following on therefrom or in accordance with an IEEE 802.15 standard or a standard based thereon or following on therefrom.

9. The method according to claim 1, wherein one or more of the following standards or standards based thereon or following on therefrom is/are used for time-triggered communication: SAE AS6802, IEEE 802.1Q, IEEE 802.1AS, IEEE 1588.

10. A computer network for transmitting messages, wherein the computer network comprises two or more computing nodes (101-108, X107, X108, X109), which computing nodes (101-108, X107, X108, X109) are interconnected via one, two, or more star couplers (201, 203, 205, 207, 210, 211, X201, X202) and/or at least one multi-hop network (1000), wherein each computing node (101-108, X107, X108, X109) is connected to a star coupler (201, 203, 205, 207, 210, 211, X201, X202) or a multi-hop network (1000) via at least one wireless or wired communications link (110, 110a, 110b, 110c, 110d), and wherein the computing nodes (101-108, X107, X108, X109) exchange messages with one another and with the one or more star couplers (201, 203, 205, 207, 210, 211, X201, X202) and/or multi-hop network (1000),
wherein:
a first group of components is provided, wherein the components of the first group send and/or forward and/or receive messages via one or more wired link(s) (110), wherein the first group comprises one, two, or more component(s), and wherein each component of the first group is either a computing node (101, 102, 103, 104, 105, X108), a star coupler (201, 203, 205, 207, 210, 211, X201), or a star coupler of a multi-hop network (1000),
a second group of components is provided, wherein the components of the second group send and/or forward and/or receive messages via one or more wireless link(s) (110a, 110b, 110c, 110d), wherein the second group comprises one, two, or more component(s), and wherein each component of the second group is either a computing node (107, 108, X107, X109) or a star coupler (201, 210, 211, X201, X202),
each component of the first and the second group has a local clock,
the clocks of the components of the first and the second group are synchronised to one another or are synchronised with one another,
the components of the first and the second group send and/or forward and/or receive messages in a coordinated manner in accordance with a common communications schedule.

11. The computer network according to claim 10, wherein one, two, or more of the components of the first group also send and/or receive and/or forward messages via one or more wireless links.

12. The computer network according to claim 11, wherein the components of the first group that send and/or receive and/or forward messages via one or more wireless links send and/or receive and/or forward these messages in accordance with the common communications schedule.

13. The computer network according to claim 10, wherein one, two, or more of the components of the second group also send and/or receive and/or forward messages via one or more wired links.

14. The computer network according to claim 13, wherein the components of the second group that send and/or receive and/or forward messages via one or more wired links send and/or receive and/or forward these messages in accordance with the common communications schedule.

15. The computer network according to claim 10, wherein the sending times of the time-triggered messages in the communications schedule are selected in such a way that time-triggered messages are sent at the same time or in an overlapping manner only over those wireless communications links with which there is no disturbance of the message transmission.

16. The computer network according to claim 10, wherein messages are transmitted via wired communications links in accordance with an IEEE 802.3 standard or a standard based thereon or following on therefrom.

17. The computer network according to claim 10, wherein messages are transmitted via wireless communications links in accordance with the IEEE 802.11 standard or a standard based thereon or following on therefrom or in accordance with an IEEE 802.15 standard or a standard based thereon or following on therefrom.

18. The computer network according to claim 10, wherein one or more of the following standards or standards based thereon or following on therefrom is/are used for time-triggered communication: SAE AS6802, IEEE 802.1Q, IEEE 802.1AS, IEEE 1588.
